(19) United States
(12) Patent Application Publication
(10) Pub. No.: US 2021/0125165 A1
(43) Pub. Date: Apr. 29, 2021

(54) POS SYSTEM WITH PERSONAL DEVICE INTEGRATION USING PROVISIONED URL

(71) Applicant: Clover Network, Inc., Sunnyvale, CA (US)

(72) Inventors: Leif Borden, Oakland, CA (US); Gareth Glenn Dsouza, Sunnyvale, CA (US); Cameron Garcia, San Jose, CA (US); Krishna Chinya, Sunnyvale, CA (US); Steve Chou, Campbell, CA (US); Kejun Xu, Sunnyvale, CA (US); Ross Peterson, Mountain View, CA (US); Boris Minkin, Randolph, NJ (US); Pharson Chalermkraivuth, Sunnyvale, CA (US); Mariko Sanchez, San Jose, CA (US); Anastasiya Shevchenko, Mountain View, CA (US); John Daniel Beatty, San Carlos, CA (US)

(73) Assignee: Clover Network, Inc., Sunnyvale, CA (US)

(21) Appl. No.: 17/084,281

(22) Filed: Oct. 29, 2020

Related U.S. Application Data
(60) Provisional application No. 62/927,517, filed on Oct. 29, 2019.

(51) Int. Cl. G06Q 20/20; G06Q 30/06; G06Q 20/40; G06Q 20/42; G06Q 20/32; G06K 7/10; G06K 7/14; G06K 19/06; G06K 19/07; G06Q 30/00; H04L 29/08; H04N 1/00; H04W 4/14

(52) U.S. Cl. CPC G06Q 20/204; H04W 4/14; G06Q 20/40; G06Q 20/42; G06Q 20/3255; G06Q 20/3276; G06K 7/1095; G06K 7/1417; G06K 19/06037; G06Q 20/209; G06K 19/0723; G06Q 30/0185; G06Q 20/202; H04L 67/26; H04N 1/00326; G06Q 30/0633

(57) ABSTRACT

Systems and methods for efficiently processing a transaction using a point of sale (POS) system and a URL which is provisioned to a purchaser in the transaction are disclosed. A purchase order input for a purchase order for the transaction can be received via a register application on the POS. A payment interface URL is generated and a payment interface for the purchase order is provided at a web page identified by the payment interface URL. Payment authorization is received for the purchase order, from a payment processor, in response to a payment interface input provided on the payment interface. A confirmation of the payment authorization is provided to the register application.

### CROSS REFERENCE TO RELATED APPLICATION

This application claims the benefit of U.S. Provisional Patent Application No. 62/927,517, filed Oct. 29, 2019, which is incorporated by reference herein in its entirety for all purposes.

### BACKGROUND

Traditional methods for completing a transaction include the establishment of an order by a merchant and the payment of the order by the purchaser. The merchant can register a purchase order in a system and provide the customer with a receipt comprising the value of the goods to be purchased, so that the customer can proceed to payment. Cash and payment cards are widely used payment resources. The era of digital payments has brought on new possibilities to complete transactions and payments, such as digital wallet platforms and mobile payment services. Digital wallet services allow customers to make payments using dedicated resources such as mobile applications associated with the digital wallet service provider. In some cases, both the merchant and the customer need to be associated with the same service provider in order to successfully complete a transaction, requiring the customer to download and register in a third-party application compatible with the merchant's payment system so that the transaction can be affected by the customer via the third-party application.

### SUMMARY

This disclosure relates to systems and methods for efficiently processing a transaction using a point of sale (POS) system and a URL which is provisioned to a purchaser in the transaction. The purchaser can be a customer. The POS system can comprise a POS device, such as a POS terminal, operated by a merchant. The transaction can include several components including the creation of a purchase order for the transaction, a request for a payment authorization from a payment processor to settle the transaction, and the receipt of that payment authorization by the POS system. The POS system and a personal device of the user can be integrated by using a server architecture and the provisioned URL to collaboratively execute one or more of those transaction components.

The systems and methods disclosed herein utilize the URL to allow for tight integration between a POS device, such as a POS terminal, and a personal device of the purchaser such as a smartphone, tablet, or wearable. The disclosed systems include a server architecture that hosts the resources identified by the URL, a POS device, and a system for providing the URL. In specific embodiment of the invention, the server architecture can be one or more servers hosting the resources identified by the URL. The system for providing the URL can be as simple as a piece of paper with an encoded URL, such as in the form of a QR code, to be scanned by an image sensor on the personal device. The system for providing the URL can alternatively be an RFID tag with the encoded URL, such as in the form of an NFC tag, located thereon for interrogation by an RFID reader on the personal device. The system for providing the URL can alternatively or in combination include a wireless network or link such as an iBeacon providing a Bluetooth low energy (BLE) connection or router providing a Wi-Fi connection. The system for providing the URL can alternatively or in combination include any form of networked communication that can be initiated by the server architecture and terminate with the delivery of the URL to the personal device. For example, the system could be a networked system for transmitting SMS messages to the personal device upon receiving instructions to do so from the POS terminal.

The URL serves to connect the personal device with the POS device as it is an address for a resource provided by the server architecture, and by extension then with the POS device, since the server architecture is also utilized by the POS device. In specific embodiments of the invention, the server architecture is used by the POS device in the ordinary course of business such as for passing payment authorization requests for payment cards presented at the POS device up to payment processors, returning payment authorization confirmations in response thereto, updating the software on the POS device, and generally providing centralized security and administration services for a network of POS devices which includes the POS device. The resource provided by the server architecture can allow the personal device to perform one or more operations associated with a transaction such as initiating the transaction, creating or updating a purchase order for the transaction, obtaining information regarding the purchase order for display on the personal device, and requesting payment authorizations for the transaction in response to information or commands provided on the personal device.

In specific embodiments of the invention, the URL will be an address for a resource hosted by the server architecture which can display information regarding the transaction on the personal device, receive inputs from the personal device to affect the transaction, or both. For example, the URL could be the address of an order page hosted by the server architecture or a payment page hosted by the server architecture. The payment page can include integrations with various web-based payment systems such as Google Pay, Apple Pay, other third-party payment systems, or a specific payment system offered by the administrator of the server architecture. The order page can provide a user with an order interface for creating a purchase order for the transaction (e.g., a menu and accompanying order builder application for a restaurant transaction). Alternatively, the order page can provide the user with the ability to initiate a transaction with the merchant generally, which can be supported by the provisioning of credit card information or login credentials for an integrated web-based payment system. In specific embodiments of the invention, the system will provision multiple URLs to the purchaser such as a first URL which is an address for an order page and a second URL which is an address for a payment page. URLs can be provisioned to the purchaser directly by the merchant or POS device, or via QR code, SMS messages, RFID tags, longer range wireless links such as BLE or Wi-Fi, e-mail, etc.

In specific embodiments of the invention, a method for processing a transaction is provided. The method includes providing access, via a register application on a POS terminal, to a purchase order for the transaction. The method also includes providing a URL to a customer. The steps of providing the URL and access to the purchase order can be conducted in either order as the URL can be provided to the customer to allow them to initiate the transaction, or the URL can be provided to the customer to affect an existing transaction. The method also includes providing a payment interface or an order interface at a web page identified by the URL. The URL associated with the order interface can be the same as, or different than, the one associated with the payment interface. In this way, one or more URLs can be provided to a customer to complete a given transaction, and the different URLs can be provided via different mediums such as NFC to access an order interface and scanning a printed QR code to access a payment interface. If the payment interface is provided, the method can include receiving a payment authorization for the purchase order, from a payment processor, in response to at least one user input provided on the payment interface. The method can then, if the payment is authorized, proceed with providing a confirmation of the payment authorization to the register application on the POS terminal. If the order interface is provided, the method can include receiving customer selections for the purchase order, in response to at least one user input provided on the order interface. The inputs can be provided on the personal device and received by the server architecture. The method can then proceed with providing the customer selections to the register application on the POS terminal.

In specific embodiments of the invention, one or more non-transitory computer-readable media are provided. The one ore more computer-readable media store instructions which, when executed by one or more processors in a system, cause the system to: receive, over a network connection and on behalf of a register application on a point of sale terminal, a purchase order input for a purchase order for a transaction; generate a payment interface URL; provide a payment interface for the purchase order at a web page identified by the payment interface URL; receive a payment authorization for the purchase order, from a payment processor, in response to a payment interface input provided on the payment interface; and provide a confirmation of the payment authorization for processing via the register application.

In specific embodiments of the invention, one or more non-transitory computer-readable media are provided. The one or more computer-readable media store instructions which, when executed by one or more processors in a system, cause the system to: receive a purchase order input, for a purchase order for a transaction, in a register application on a point of sale terminal; transmit, over a network connection, the purchase order input to a server architecture; receive, over the network connection, a payment interface URL for the purchase order from the server architecture; provide the payment interface URL for the purchase order; and receive, by the register application, a confirmation of payment authorization for the purchase order, from the server architecture, in response to a payment interface input provided on the payment interface.

In specific embodiments of the invention, a system for processing a transaction is provided. The system comprises a point of sale terminal, a server architecture, and one or more non-transitory computer-readable media storing instructions. The instructions, when executed by the system, cause the system to: receive, via a register application on a point of sale terminal, a purchase order input for a purchase order for a transaction; generate a payment interface URL; provide a payment interface for the purchase order at a web page identified by the payment interface URL; receive a payment authorization for the purchase order, from a payment processor, in response to a payment interface input provided on the payment interface; and provide a confirmation of the payment authorization for processing by the register application.

### BRIEF DESCRIPTION OF THE DRAWINGS

FIG. 1 illustrates a series of images for a transaction flow, in accordance with specific embodiments of the invention disclosed herein. FIG. 2 illustrates a flow chart for a scan-to-pay method, in accordance with specific embodiments of the invention disclosed herein.

FIG. 3 illustrates a state transition diagram of a system capable of executing some of the flow chart steps in FIG. 2, in accordance with specific embodiments of the invention disclosed herein.

FIG. 4 illustrates a state transition diagram that involves a URL encoded in an RFID tag, in accordance with specific embodiments of the invention disclosed herein.

FIG. 5 illustrates a flow chart for an approach in which multiple URLs are provided to a user to complete more than one component of a transaction.

### DETAILED DESCRIPTION

Systems, and associated methods, for efficiently processing a transaction using a point of sale (POS) system and a URL which is provisioned to a purchaser in the transaction in accordance with the summary above, are disclosed herein. The examples in this section are provided to more fully explain various specific embodiments of the invention and should not be interpreted to constrict the full scope of the invention disclosed herein. The various concepts taught by the disclosed examples can be used alone or in combination as each specific example is provided to illustrate, not a system or method in isolation, but potential facets of specific embodiments that can be formed by drawing lessons from multiple examples.

Using specific embodiments of the invention summarized above, a personal device with a web browser can be integrated, without downloading an application or any customized software, with a POS device for purposes of conducting a transaction. In specific embodiments of the invention, the integration can also be achieved without installing any customized software on the POS device and without increasing transaction times. These benefits can be realized in embodiments in which the server architecture provides payment authorizations, received in response to the operation of the payment interface on the personal device, using the same channel as for payment authorizations received in response to payment authorization requests that originate from the POS device itself. In these embodiments, the server architecture can administrate both the request and receipt of the payment approval for a payment authorization request originating on the personal device and send a trusted confirmation of payment authorization to the POS device without requiring the POS device to conduct any additional processing steps. In specific embodiments of the invention, the integration with the POS device allows for any input on the personal device to have a direct and seamless impact on any transaction origination and processing workflow already in use on the POS device. For example, a restaurant table ordering system can immediately display the fact that one table has altered their purchase order by ordering another item from a menu using their personal device. As another example, the same system can be used to automatically mark a table as having paid using a personal device so that a restaurant manager can see if a group of people has settled their transaction before exiting the restaurant. In specific embodiments of the invention, the register application will be a native application of the POS device and the POS device will be sold or maintained by an entity that has a special relationship with the administrator of the server architecture, or is the same entity that administrates the server architecture. For example, a single company could build and maintain the POS devices, and own and administrate the server architecture. In these embodiments, the level of integration can be increased due to the increased trust associated with the link between the server architecture and the POS devices.

A method for processing a transaction can include the steps of providing access to a purchase order for the transaction via a POS device and providing a URL to a customer. Either step can be conducted first, as the resource identified by the URL can be used to initialize the transaction or create the purchase order. For example, a user could initialize a transaction by being provided with a URL upon entering a quick service restaurant by taking a picture of a QR code which encoded the URL. The user could then begin ordering using the same personal device that took the picture, and the purchase order for the initialized transaction could automatically show up on the restaurant's POS system as a food order that required fulfillment. As a counter example, in which the steps are conducted in the opposite order, a merchant could initialize a transaction by scanning items for purchase at a checkout counter of a store and the user could be provided with a URL by taking a picture of a QR code which encoded the URL and was located at the checkout counter. The user could then use the same personal device that took the picture to request a payment authorization to settle the transaction. Regardless of which step is conducted first, the purchase order for the transaction will appear integrated with the standard transaction workflow offered by the POS system, and the user will be provided with a URL to allow them to link to a networked resource to initialize the transaction or otherwise affect the transaction.

In specific embodiments of the invention, the URL is provided in various ways. The URL can be generated and encoded as a tinyurl to keep the information payload compact. As mentioned above, the URL can be encoded in a QR code and scanned by a purchaser. The QR code could be a fixed code on a piece of paper or a modifiable code presented on a display. Methods in accordance with these embodiments would involve encoding the URL in a QR code and displaying the QR code on the display. The fixed code could be posted for use by multiple parties (e.g., a sticker on a POS device or table placard in a restaurant) or could be provided specifically for a given user (e.g., a QR code printed on a purchase order receipt). Methods in accordance with these embodiments would involve encoding the URL in a QR code and printing the QR code (e.g., on a purchase order receipt). The device which scanned the QR code could then use the URL to access and provide the networked resource to the user. Although QR codes are used throughout this disclosure as an example, various other encodings and transmission mechanisms can be used in place of QR codes including those that encode the URL in the non-visible light spectrum such as via ultraviolet or infrared light. The encodings also do not need to be spatial encodings as the URL can be encoded through bursts or other temporal patterns. As another example, the URL could be encoded in an RFID device which would be interrogated by an RFID reader on a personal device of the purchaser. Methods in accordance with these embodiments would involve encoding the URL in an RFID tag. Again, the same device which interrogated the RFID tag could then use the URL to access and provide the networked resource to the user. As another example, the URL can be provided using a networked system for transmitting SMS messages to the personal device upon receiving instructions to do so from the POS device or server architecture, or any other forms of networked communication that can be initiated by the server architecture and terminate with the delivery of the URL to the personal device. As another example, the URL can be provided over a local network located in a store or place of business. In specific embodiments, the POS device itself will provide this network, such as by serving as a Wi-Fi hub for the store or place of business. In other examples, the URL can be provided by a wireless link such as via a BLE transmission from an iBeacon. The URL can be provided during an initial handshake with the personal device as it is configured to operate on the local network. The URL can be provided to the personal device in the form of a custom landing page for each personal device as soon as they connect to a public network such as a Wi-Fi network of a given store. The URL can also be provided to the user via location-based internet advertising on social media platforms users access when they are in a given establishment, or in general internet browser window advertisements. For example, a user checking social media in line at a coffee shop on their phone could thereby quickly see that ordering via their mobile device was a convenient solution that did not require downloading an application, and be provided with the URL in the form of a hyperlink on their device.

In specific embodiments of the invention, the resource identified by the URL will be inherently linked to the transaction. The inherent link can be created in various ways. For example, the URL can be to an order creation page such that the page was created specifically for a given transaction. As another example, a table or specific customer in a place of business could be associated with a transaction via the POS device, and a URL encoded in an RFID tag or iBeacon located on the table could be configured to link to a page for that specific transaction. As another example, the URL could be generated and printed on a receipt such that it was inherently linked to that the transaction associated with the receipt. The links can be managed via transaction numbers issued by the POS device. The transaction number initialized by the POS device could be encoded with the URL when it was provided to the customer. In these embodiments, the URL could be provided in a form that was easily alterable such as a QR code provided on a networked display or in an SMS message sent to a user's phone. In either of these situations, the POS device or server architecture could already have a transaction number stored for the transaction, and the URL could be adjusted to include the transaction number or a reference thereto. Methods in accordance with these embodiments could include encoding the URL along with a transaction number for a transaction. As an example, the URL could include an encoding for an HTTP get request with a transaction number and the transaction number could be sent to the server architecture in an HTTP get request. When a customer utilized such a URL, the server architecture could provide an order page for the transaction to the customer's personal device. If the server architecture had not initialized the transaction yet, the server architecture could simultaneously create a blank purchase order for the transaction.

In specific embodiments of the invention, the resource could be indirectly linked to a specific transaction by being specifically instantiated by the server architecture for an aspect of the system that had a unique semantic link with the transaction. The aspect could be a specific location for the purchaser in a given place of commerce, a specific table or checkout counter in a given place of commerce, or a specific vendor who was only capable of conducting a transaction with one purchaser at a time. A universal unique identifier for that aspect could be delivered to the server architecture from the personal device and indirectly link the personal device to a specific transaction. For example, the resource could be a payment page or order page for a given table in a restaurant, and the status of the table in the POS system would indirectly link the resource with a transaction. Accordingly, if the table was currently associated with an open transaction, the resource for the table would be linked to that transaction when accessed. Alternatively, if the table was not associated with an open transaction, accessing the resource for the table could cause the transaction to be opened by the POS system and automatically associated with that table. As another example, the URL could be provided to a personal device when first accessing a wireless network of a given place of commerce and could include an IP address assigned to the device by the wireless network. The information could alternatively be any network information associated with the connection between the personal device and the wireless network or a hash thereof. As long as the network was designed to persist the network information for the course of a potential transaction, it could be used as an indirect link for any transactions conducted by the associated purchaser.

In specific embodiments of the invention, the resource will not be linked to a transaction, and will instead include prompts for information to form a link between the transaction and the purchaser. For example, a user could be provided with a URL for an order page by scanning a QR code at a table in a restaurant. The user could then access the order page and enter an order along with their phone number to complete the order. Alternatively, the order page could simply allow the user to enter credentials for a third-party web-based payment system to create a tab or initialize a transaction generally with a merchant. Such an order page could also include a field for entering a phone number, or the server architecture could receive the phone number from the web-based payment system upon authorization of the customer. Subsequently, their phone number could be used to send an SMS message with a URL that was inherently linked to the existing transaction in order to access a payment page for the transaction. The SMS message could be sent out immediately, so that the user could pay at any time, or be initiated at the POS device to allow the merchant a chance to review the order before allowing payment.

In specific embodiments of the invention, and in keeping with some of the examples provided above, access to a purchase order can be provided on the POS device. The purchase order can be initialized on the POS device and accessed thereon, such as by using an integrated register application on the POS device. Alternatively, the purchase order can be initialized by the server architecture or personal device, and subsequently accessed on the POS device. For example, a transaction for a specific table in a restaurant can be initialized by a user when they sit down at the table, and a merchant can subsequently review the purchase order for fulfillment using their POS device and associated order fulfillment systems in association with that table. As another example, a transaction for a specific user can be initialized by a user with their personal device, where the server architecture associates the transaction with the personal device, and a merchant can review the purchase order on the POS device by selecting the transaction associated with the personal device when the personal device is presented and identified at the POS device. The device can be identified automatically in these cases using an RFID tap, presentation of information by the device's display or LEDs, presentation of information by the device's speakers, or any other method of expressing a digitally assigned identity of the device.

In specific embodiments of the invention, the POS device will provide access to the purchase order and/or receive payment authorization for the transaction using a register application. The register application can be an integrated portion of the operating system of the POS device. The register application can be used by the operator of the POS device to build and review purchase orders generally, to control order fulfillment workflows (e.g., show table order status in a restaurant), to send request for payment authorizations, to receive payment authorizations, and to settle transactions on the POS device. In specific embodiments of the invention, the register application can be instantiated by an operating system on the POS device. The operating system can be the Android operating system. In specific embodiments of the invention, the register application can be a native application running on the POS device with an enhanced degree of security, access, and integration with the operating system. In these embodiments, payment authorizations that are received in response to the action of the payment resources of the server architecture can be processed and used to settle transactions on the POS device using the same channels used to process authorizations received for other payment types, such as those for card-present transactions and others that require the presentation of information at the POS device itself. This is possible due to the trusted channel of communication between the native register application and the server architecture. In specific embodiments of the invention, providing a confirmation of the payment authorization to the register application can include transmitting a push notification with an order identifier for the transaction from the server architecture to the register application. The register application could thereby be kept in synch with payment approvals from the personal devices without having to send status requests. Furthermore, faster processing times are available for this level of trust because any payment information provided at the payment page does not need to be first shuttled down to the POS device before being sent back up for authorization by a payment processor. Furthermore, the level of integration assures that no modifications need to be made to the order fulfillment or purchase order review workflows of the merchant to accommodate the new channel by which order modifications can be provided. The same register application will be used regardless of whether the order modifications are entered at the POS device or on the personal device.

In specific embodiments of the invention, the resource provided by the server architecture at the URL will be used for allowing a customer to affect a purchase order from their personal device. The user could create a purchase order for a transaction, add or remove items from the purchase order, and finalize the purchase order all from their personal device. For example, specific methods disclosed herein could include providing an order page URL to the customer and providing an order interface at an order page identified by the order page URL. The order page URL could include a transaction number, or variant thereof, and the order page could be a web page specifically provided by the server architecture for that transaction. The order interface can include buttons and form fields for allowing a user to initialize or modify the purchase order. For example, the order interface could include pictures and descriptions of items for order and widgets to allow a user to select those items for purchase. Alternatively, the order page could be a generic web page provided by the server architecture, and the order interface could include form fields for allowing a user to identify a transaction indirectly or directly. For example, when confirming the order, the purchaser could be prompted for a phone number to identify themselves, a table number or checkout line to identify where they are, or some other information that is directly or indirectly associated with the transaction. The server architecture can receive customer selections for the purchase order in response to at least one user input provided on the order interface. For example, a user could identify a medium sized soda using a radio button on an order interface, and a tag identifying the medium sized soda and associated with the radio button in the code used to instantiate the order interface could be sent to a server architecture. Subsequently, the customer selections can be provided to the register application by the server architecture. Once received, the selections can be treated the same way as if they had been entered directly on the POS device. For example, an identifier for the medium sized soda and information identifying the transaction number or a table number could be sent from the server architecture to the POS device, and appear as an order due for that table number on the merchant's order fulfillment program.

In specific embodiments of the invention, the resource will be used for allowing a customer to affect a payment for the transaction from their personal device. The URL could be a payment page URL and the resource could be a payment interface at a payment page identified by the payment page URL. The payment page URL could include a transaction number, or variant thereof, and the payment page could be a web page specifically provided by the server architecture for that transaction. The payment interface can include buttons and form fields for allowing a user to enter payment information and seek a payment authorization to settle the transaction. The payment interface can include HTML (Frames or other web elements which allow third party payment processors or electronic wallet administrators to receive payment information from the user without the server architecture needing to handle that information. For example, a credit card number could be sent directly to an online credit card payment processor or a login credential for a web-based payment solution could be sent directly to the administrator of that solution. The server architecture could offer a high degree of extensibility to POS systems to which it was a part in that any type of web-accessible payment solution could be integrated in with a POS device using such payment pages. So long as the server architecture is able to link the payment page to the appropriate transaction and receive payment authorizations in response to user provided authentication information, nearly any form of payment can be added using this approach.

In specific embodiments of the invention, the system will send more than one URL to the purchaser. For example, the user may decide they want the order changed after submitting it, and a fresh URL for modifying the purchase order could be delivered in response to a request. However, in the alternative, the same URL could be persisted and allow a user to return and modify their order. As another example, different URLs will be provided to allow a user to interact with the POS system in different ways. One URL could be an order page URL sent to create a purchase order and one URL could be a payment URL sent to create a payment page. In a specific embodiment of the invention, an order page URL will be generally accessible to a user and will include a field of identifying information for the user which also serves as a channel for sending a second URL to the user. The second URL could be a payment page URL. In a specific embodiment of the invention, a method includes providing an order page URL to the customer by encoding the order page URL in a QR code and providing a payment page URL in an SMS message. The first URL could include a request for a customer phone number or login credentials for a web-based payment system with access to the customer phone number. The second URL could be sent in an SMS message out to that phone number. The SMS message could be sent immediately or when the user was ready to pay. Transmission of the SMS message could be immediate, or be initiated by a command received on the POS device. For example, a customer could alert a merchant that they were ready to pay, and the merchant could be given a chance to review the order before initiating transmission of the second URL for payment. The order page and payment page URLs can be provided to the customer via multiple other ways. For example, the order page URL can be accessed by a customer by tapping an NFC location and the payment page URL can be provided via a QR code. The NFC location could be provided at a POS, a restaurant table, a dedicated location in a business, etc. Once the customer completes the order, the payment page URL could be provided in a QR code that can be printed on the order receipt, or displayed in the POS device or merchant device. Alternatively, the same URL provided to access the order page can allow the user to proceed to the payment for the order. For example, the order interface can include buttons or links to redirect the customer to the payment page for the order, with no need to generate a new URL for the customer to access the payment interface. As mentioned before, URLs can be provided to the customer not only via QR codes, SMSs and NFC technology, but also via e-mail, printed paper, displayed on a screen in the POS or merchant device, broadcasted over a local network, etc. The URLs can be associated with generic interfaces, such as a menu page or a business page where each customer may be required to register and provide credentials to proceed, or with dedicated interfaces, such as a table-specific page in a restaurant. The URLs can also be individually generated for each individual transaction, directing the customer to a dedicated interface associated with the transaction. For example, a customer may place an order, via an order interface in their mobile devices or directly with a merchant or POS devices, and be provided with a dedicated URL for the specific order. If the order was placed by tapping an NFC location or scanning a code at a dining table, the order may be associated with the table. The payment URL could then alternatively be associated with the table that originated the order, or be generated individually for each transaction, even when transactions are associated with the same table or order page, such as for two subsequent transactions from different customer sitting in the same table at different times.

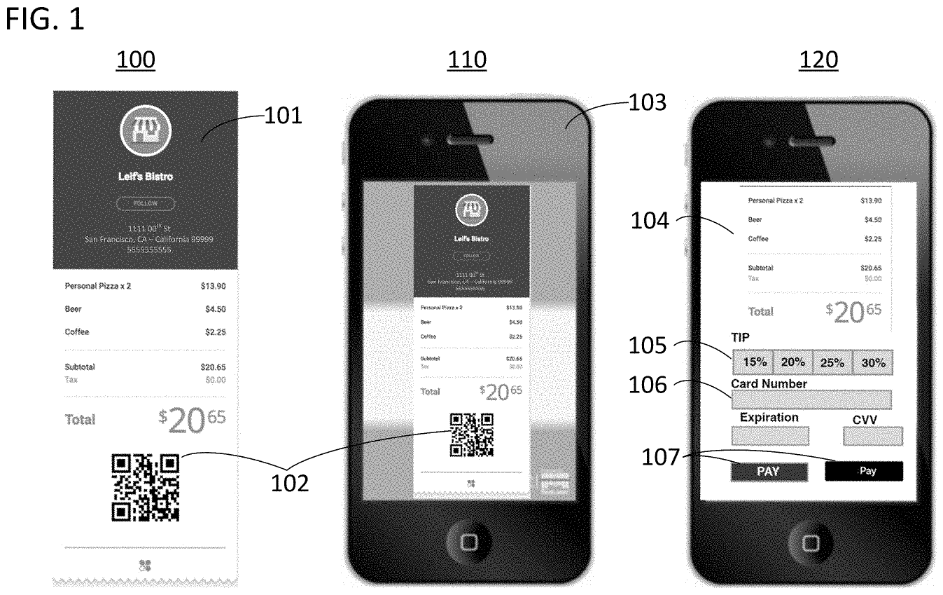

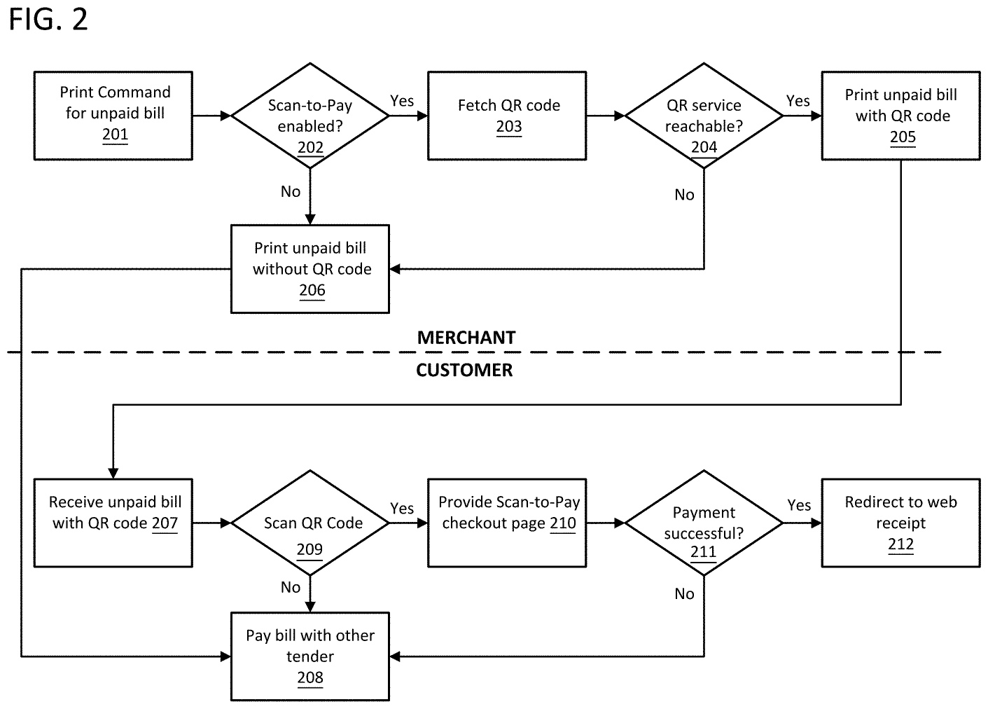

FIG. 1 illustrates a series of images for a transaction flow in accordance with specific embodiments of the invention. Image 100 displays an unpaid bill 101 with a purchase order and an encoded URL in a QR code 102. The unpaid bill could be displayed on a POS device. At this stage, the merchant can print the unpaid bill and the QR code 102 will be available to hand it to a customer so long as QR code printing is enabled on the POS device. Image 110 includes a personal device 103 on which a user has scanned the QR code 102. The user can use the built-in camera of their personal device to scan the QR code. At this point, the QR code 102 redirects the personal device 103 to a Web site which fetches the order contents from the server architecture using an encoding from the URL. In alternative embodiments, the order details are encoded as part of the URL itself in other embodiments. The order pages and payment pages disclosed herein can all be mobile optimized. The orders can be fetched on demand by the server architecture whenever the QR codes are scanned. Image 120 shows a payment page 104 for a user to complete the transaction. Page 104 could also be an order page or any other page associated the URL encoded in QR code 102. Page 104 can provide information about the purchase and interfaces for the customer to interact with. For example, the customer can enter a tip amount (if tips are enabled for the POS system) via an interface, such as interface 105. The customer can also enter payment information such as credit card information via interfaces such as interface 106. Additional interfaces, such as interfaces 107, that provide options for payment via a proprietary or third-party payment application, such as Apple Pay or Google Pay can also be displayed. In this way, the customer may be able to complete a transaction via a payment application or electronic wallet associated with, or accessible from, the payment page, or by providing payment information directly in the payment page. Payments can then be processed using the electronic wallet, a third party or proprietary payment application, or by directly integrating the mobile device to the payment system associated with the POS device, in the same way as a regular transaction is conducted directly at the POS device. In specific embodiments of the invention, the payment options displayed by the server architecture will depend on what type of personal device is detected and are default payment experiences. For example, if the server architecture detected that the browser was a Safari browser on an iPhone, the server architecture would provide an option for Apple Pay in response. The server architecture could alternatively provide an option for entering credit card information if an electronic wallet is not available. In specific embodiments of the invention, the server architecture will then redirect the browser on the personal device to a paid web receipt upon success of the payment. The next step of the flow could include a notification of success step. In this step the personal device could receive a push notification of a successful payment, a web or operating system orders app on the POS device could be updated as paid, and a web or operating system transaction app could be updated with successful payment information on the POS device. If enabled, a receipt could also be printed at the point of sale terminal.

FIG. 2 illustrates a flow chart for a scan-to-pay method in which a user scans an encoding, such as a QR code, in order to be taken to a payment page to authorize a payment for a transaction. Steps illustrated on the top of the chart are conducted on the POS device and by the merchant. Steps illustrated on the bottom of the chart are conducted on the personal device and by the user. In a first optional step 201 a request to print an unpaid bill is received on a POS device the request can be a print command issued by the operator of the POS device. In a first decision block 202, if scan-to-pay is not enabled in the POS device, the flow chart continues to a step 206 in which a bill is printed without a QR code; and if scan-to-pay is enabled, the flow chart continues to a step 203 in which a QR code is generated or fetched and displayed. The QR can be generated and displayed by a native register application. Alternatively, the QR code can be fetched from the server architecture connected to the POS device. If the QR service is reachable, the flow chart continues to a step 205 of displaying or printing the unpaid bill with the QR code. If the QR service is not reachable, the flow chart continues to a step 206 of printing the bill without the QR code. In either of the above cases in which the bill is printed without the QR code, the bill can be paid without using the scan-to-pay channel, as represented in step 208. However, if the bill was displayed or printed with the QR code, the QR code can be provided to the user with the QR code as represented by step 207. The customer can then chose to pay using scan-to-pay or chose to pay using a conventional method such as tendering a credit card in step as represented by step 209. If at this point the user elects to not pay using other tender, they can do so it step 208. However, in the alternative, the user may scan the QR code with their personal device, and, upon successfully scanning the QR code, the customer's personal device will subsequently land on a checkout page, as represented in step 210, which can be similar to the payment pages disclosed elsewhere herein. The user can then enter credit card details and tip details or use another connected payment system accessible via the checkout page. In a next step 211, payment on the checkout page will either be successful, in which case the user's personal device will be redirected to a web receipt via step 212, or not, in which case the user can still pay using an alternative method, via step 208.

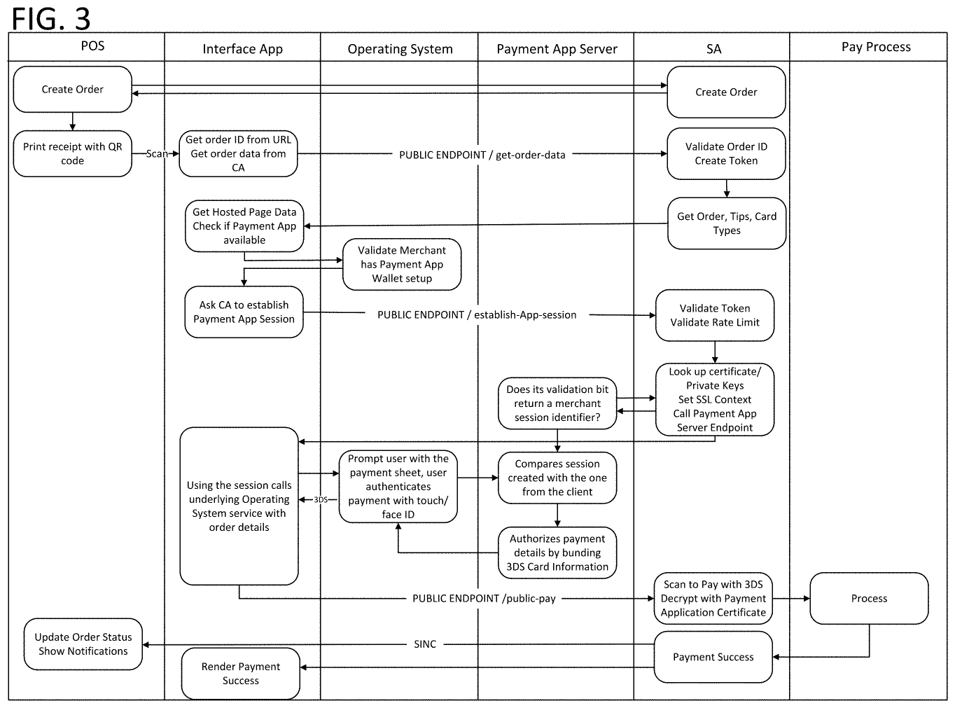

FIG. 3 illustrates a state transition diagram of a system capable of executing some of the flow chart steps in FIG. 2. The nodes of the state transition diagram and the specific processing steps are given with reference to a server architecture (SA) which can exhibit many of the features disclosed herein, a POS device, and a payment processor. The specific state transition diagram includes a mobile device, the operating system of the mobile device, an interface application, and a server, that can be a payment application server. In specific embodiments of the invention, integration with third-party systems can be provided. For example, the state transition diagram could be provided with reference to use of the Apple Pay payment system. In those embodiments, the mobile device can be an Apple iPhone, with a Web React application, an Apple OS and an Apple Server. However, the illustrated approach can be modified to accommodate various other architectures and payment systems.

The entire workflow of FIG. 3 is split up into four stages: an order creation stage, a scan QR code stage, a Merchant Session, and a payment decryption and processing stage. In the order creation stage an order is created, for example using the register app on the POS device. Next the bill for the same is displayed and/or printed with a QR code that has a URL encoded in it. The URL can point to an interface application such as a react app (e.g., https://www.{SA}.com/scan-to-pay/{orderId} where the {orderId} value is an identifier for the order and {SA} is the domain of the administrator of the server architecture). The next stage is the scan QR code stage. In this stage, the customer scans the QR code and opens the link in a browser. In the Apple Pay case, the customer can be using a Safari browser. In the next step an interface application, which in a nonlimiting example could be a React application, loads a payment page and may execute a GET/{CA version}{tx_type}/{orderId} to obtain minimal order and merchant information. The server architecture also creates a token, such as a redis token, that would then be looked up for consecutive requests and sends that to the client. The next stage is the Merchant Session stage. As shown in FIG. 3, the web application then determines if the customer device supports a payment application. For example, the web application can determine if the device supports Apple Pay and show the Apple Pay button. When clicked, the web application does a POST/{version}/apple_pay_session on the server architecture to initiate a session with Apple servers and a unique merchant session identifier is passed back from Apple to the client via the server architecture. Similar approaches can be followed for other payment applications. The personal device validates this session and then allows the user to authenticate the payment, for example via touch/face identification. The session then bundles and encrypts the payment information that is passed to the server architecture via POST/{version}/{orderId}/public_pay. The last stage is the payment decryption and processing stage. In this stage, the server architecture uses certificates and encrypted keys to decrypt the payload. The information is extracted and passed to a process for connecting to the POS device. Then post payment order management is completed and the payment/order status is synced to the POS device. Every payment made has an extra field that with “app_tracking” that is used today to determine if the payment originated from a third-party application and the application id of the same. In the illustrated case it would be an application that corresponds to the scan to pay package. All the endpoints in the state transition diagram are public and can utilize rate limiting to increase the integrity of the system.

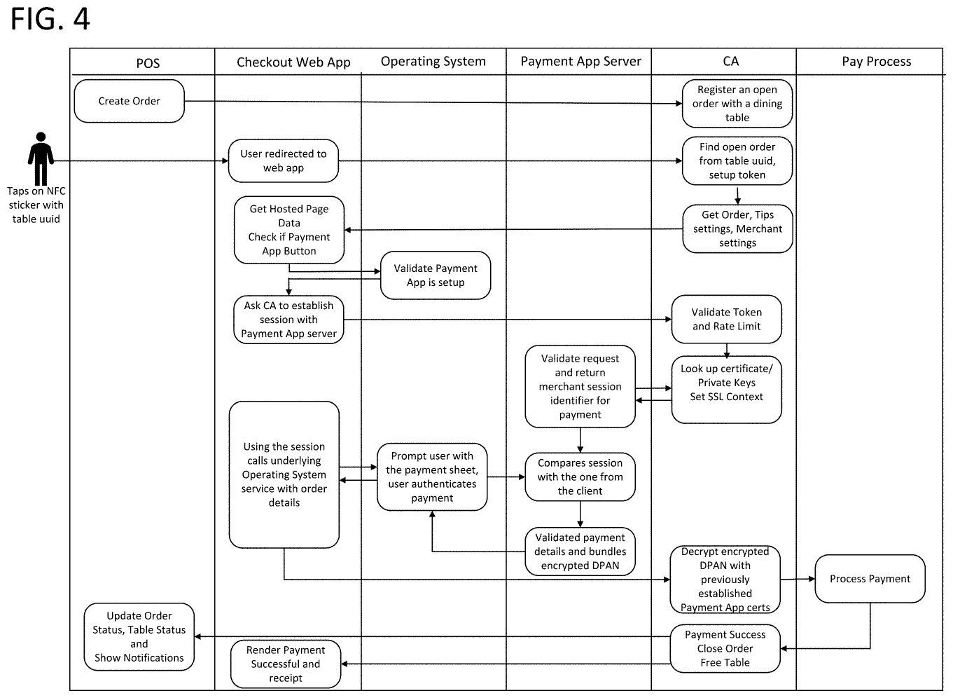

FIG. 4 presents a similar state transition diagram to FIG. 3 except for the fact that the process involves a URL encoded in an RFID tag (such as an NFC sticker) instead of a QR code. In alternative embodiments, and as described elsewhere, the URL can be encoded in a wireless signal such as a BLE signal from an iBeacon or a Wi-Fi signal from a POS device that also serves as a Wi-Fi hot spot for an establishment. The nodes of the diagram are similar. The application in this case is a checkout web application that operates on the personal user device. In this approach, a customer is navigated to a public checkout web page. The URL in the illustrated approach could include a table or POS device universal unique identifier. Tapping on a sticker on the table or POS device could prompt the user to open a link in the browser to the checkout web application. The application could then consume the universal unique identifier from the URL and call the computer architecture endpoint to get order data for the given table or POS device. The order data could then be sent back to the checkout web application and follow the token and payment flows similar to those in FIG. 3. and completes the checkout process using a digital wallet for the payment.

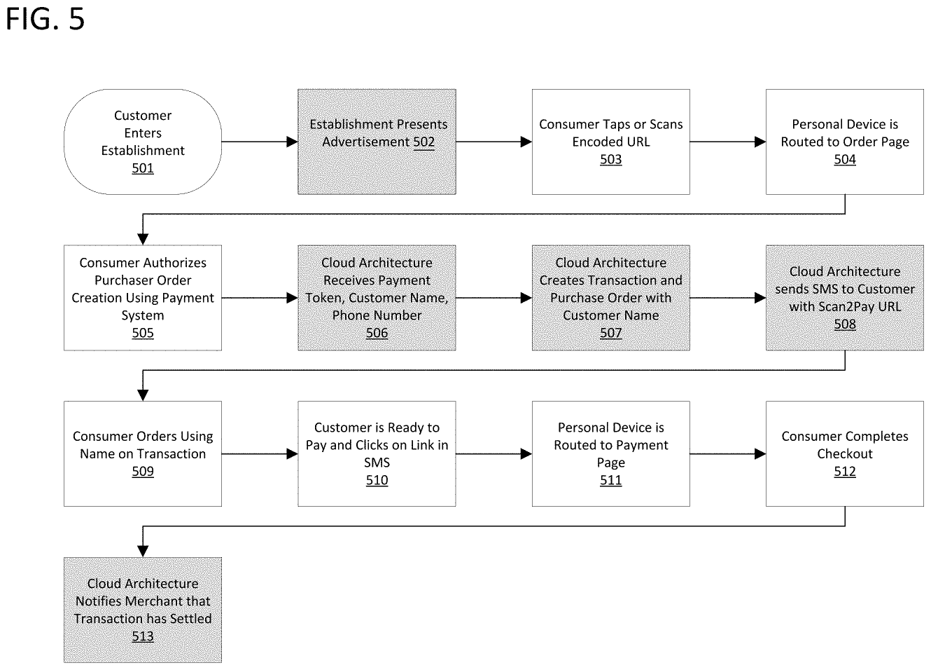

FIG. 5 illustrates a flow chart for an approach in which multiple URLs are provided to a user to complete more than one component of a transaction. Steps conducted by the personal device and purchaser are filled in white. Steps conducted by the POS device and merchant are filled in grey. In a first step 501, a customer enters an establishment such as a store, bar, or restaurant. In a next step 502, the establishment presents an advertisement such as a bar promo tent on a table with an encoded URL. The customer can then either scan (if the encoded URL is in a QR code) or tap (if the encoded URL is in an RFID tag) to obtain the encoded URL from the advertisement in step 503. In a next step 504, the personal device of the user is routed to an order page. The order page can be similar to the order pages described herein (e.g., it can allow a user to enter identifying information to serve as the basis for a future order, or it can allow the user to directly modify their purchase order). In the illustrated case, the order page includes a request for the customer to authorize a purchase order creation which is backed by a method of payment (e.g., an electronic wallet or credit card) in step 505. For example, the user could enter their Google Pay credentials. In a next step 506, the server architecture receives a payment token, customer name, and phone number from the payment system. This information can be provided from the electronic wallet after the user provides their credentials to the payment system, or it can be provided on the order page directly from the user. Next, in step 507, the server architecture creates a transaction and purchase order with the customer's name. The server architecture can then send an SMS message to the customer with a URL embedded in the message in step 508. Subsequently, the purchaser and merchant can create the purchase order for the user with reference to the customer's name in step 509. When the customer is ready to pay, the customer can click on a link in the SMS message in step 510. The personal device can then be routed to a payment page by a URL in the link in the SMS message which is associated with the purchase order and transaction that the server architecture initially created, in step 511. The customer can then complete checkout on the payment page in step 512. Finally, the server architecture can notify the merchant that the transaction has settled, in step 513. The notification can be provided to the merchant through the standard order fulfillment workflow of the POS device.

The wireless links disclosed in this application include wireless communication of any standard type or frequency band, including such standards as the Wi-Fi/IEEE 802.11 series, EDGE, the EV-Do series, Flash-ODFM, GPRS, the HSPA standards, Lorawan, LTE, RTT, the UMTS series, WiMAX, 6LoWPAN, the Bluetooth series (including Bluetooth Lower Energy (BLE)), IEEE 802.15.4-2006, Thread, UWB, Wireless USB, ZigBee, ANT+, and other standards. The RFID tags mentioned herein for transmitting URLs to the personal devices can be any kind of short range wireless communication protocols including ISO/IEC 14443, JIS-X 6319-4, ISO/IEC 18092, EMVCo specifications, any NFC Forum specification (e.g. NFC-A, NFC-B, NFC-F), and any contactless card technology specification generally.

While the specification has been described in detail with respect to specific embodiments of the invention, it will be appreciated that those skilled in the art, upon attaining an understanding of the foregoing, may readily conceive of alterations to, variations of, and equivalents to these embodiments. Although the example of web pages identified by URLs is used throughout this disclosure, any networked resource that can be identified by a digitizable address can be used instead, with the networked resource serving as a broader example of a web page, and the digitizable address serving as a broader example of a URL. The networked resource also does not need to provide access to an interface which requires a visual display, it can more generally provide access to any interface for machine interaction including auditory, haptic, gesture, or electronic communication. Any of the method steps discussed above can be conducted by a processor operating with a computer-readable non-transitory medium storing instructions for those method steps. The computer-readable medium may be memory within a personal device or a network accessible memory. These and other modifications and variations to the present invention may be practiced by those skilled in the art, without departing from the scope of the present invention, which is more particularly set forth in the appended claims.

What is claimed is:

1. One or more non-transitory computer-readable media storing instructions which, when executed by one or more processors in a system, cause the system to:
receive, over a network connection and on behalf of a register application on a point of sale terminal, a purchase order input for a purchase order for a transaction;
generate a payment interface URL;
provide a payment interface for the purchase order at a web page identified by the payment interface URL;
receive a payment authorization for the purchase order, from a payment processor, in response to a payment interface input provided on the payment interface; and
provide a confirmation of the payment authorization for processing via the register application.

2. The non-transitory computer-readable media of claim 1, wherein generating the payment interface URL further comprises:
encoding the payment interface URL along with a transaction number for the transaction.

3. The non-transitory computer-readable media of claim 1 further storing instructions which, when executed by the one or more processors in the system, cause the system to:
transmit an SMS message comprising the payment interface URL to a mobile phone.

4. The non-transitory computer-readable media of claim 1, further storing instructions which, when executed by the one or more processors in the system, cause the system to:
encode the payment interface URL in a QR code; and
wherein the QR code is subsequently displayed on a display.

5. The non-transitory computer-readable media of claim 1, further storing instructions which, when executed by the one or more processors in the system, cause the system to:
encode the payment interface URL in a QR code; and
wherein the QR code is subsequently printed on a purchase order receipt.

6. The non-transitory computer-readable media of claim 1, further storing instructions which, when executed by the one or more processors in the system, cause the system to:
encode the payment interface URL in an RFID tag.

7. The non-transitory computer-readable media of claim 1, wherein providing the confirmation of the payment authorization for processing via the register application further comprises:
transmitting a push notification with an order identifier for the transaction for processing via the register application.

8. The non-transitory computer-readable media of claim 1, further storing instructions which, when executed by the one or more processors in the system, cause the system to:
generate an order page URL;
provide an order interface at an order page identified by the order page URL;
receive customer selection inputs for the purchase order via the order interface; and
provide the customer selections inputs for processing by the register application.

9. The non-transitory computer-readable media of claim 8, further storing instructions which, when executed by the one or more processors in the system, cause the system to:
encode the order page URL in a QR code; and
transmit an SMS message comprising the payment interface URL to a mobile phone.

10. The non-transitory computer-readable media of claim 8, further storing instructions which, when executed by the one or more processors in the system, cause the system to:
request a customer phone number on the order page; and
initiate transmission of an SMS message comprising the payment interface URL to a received customer phone number based on a response to the request for the customer phone order.

11. The non-transitory computer-readable media of claim 8, further storing instructions which, when executed by the one or more processors in the system, cause the system to:
request login credentials for a web-based payment system on the order page; and
receive a customer phone number from the web-based payment system upon authenticating the login credentials.

12. One or more non-transitory computer-readable media storing instructions which, when executed by one or more processors in a system, cause the system to:
receive a purchase order input, for a purchase order for a transaction, in a register application on a point of sale terminal;
transmit, over a network connection, the purchase order input to a server architecture;
receive, over the network connection, a payment interface URL for the purchase order from the server architecture;
provide the payment interface URL for the purchase order; and
receive, by the register application, a confirmation of payment authorization for the purchase order, from the server architecture, in response to a payment interface input provided on the payment interface.

13. The non-transitory computer-readable media of claim 12, wherein:
the payment interface URL is encoded along with a transaction number for the transaction.

14. The non-transitory computer-readable media of claim 12, further storing instructions which, when executed by the one or more processors in the system, cause the system to:
display the payment interface URL in a QR code on a display.

15. The non-transitory computer-readable media of claim 12, further storing instructions which, when executed by the one or more processors in the system, cause the system to:
print the payment interface URL in a QR code on a purchase order receipt for the transaction.

16. The non-transitory computer-readable media of claim 12, further storing instructions which, when executed by the one or more processors in the system, cause the system to:
provide the payment interface URL in an RFID tag.

17. The non-transitory computer-readable media of claim 12, wherein receiving the confirmation of the payment authorization at the register application further comprises:
receiving a push notification with an order identifier for the transaction from the server architecture.

18. The non-transitory computer-readable media of claim 12, further storing instructions which, when executed by the one or more processors in the system, cause the system to:
provide an order page URL, wherein the order page URL identifies an order page with an order interface; and
wherein receiving the purchase order input, for the purchase order for the transaction, in the register application on the point of sale terminal comprises: receiving customer selection inputs for the purchase order via the order interface from the server architecture.

19. The non-transitory computer-readable media of claim 18, further storing instructions which, when executed by the one or more processors in the system, cause the system to:
display the order page URL on a display.

20. The non-transitory computer-readable media of claim 19, further storing instructions which, when executed by the one or more processors in the system, cause the system to:
provide the order page URL via a QR code.

21. A system for processing a transaction, comprising:
a point of sale terminal;
a server architecture; and
one or more non-transitory computer-readable media storing instructions which, when executed by the system, cause the system to:
receive, via a register application on a point of sale terminal, a purchase order input for a purchase order for a transaction;
generate a payment interface URL;
provide a payment interface for the purchase order at a web page identified by the payment interface URL;
receive a payment authorization for the purchase order, from a payment processor, in response to a payment interface input provided on the payment interface; and
provide a confirmation of the payment authorization for processing by the register application.

22. The system for processing a transaction of claim 21, wherein generating the payment interface URL further comprises:
encoding the payment interface URL along with a transaction number for the transaction.

23. The system for processing a transaction of claim 21, wherein the one or more computer-readable media further store instructions which, when executed by the system, cause the system to:
transmit an SMS message comprising a payment interface URL to a mobile phone.

24. The system for processing a transaction of claim 21, wherein the one or more computer-readable media further store instructions which, when executed by the system, cause the system to:
encode the payment interface URL in a QR code; and
wherein the QR code is subsequently displayed on a display.

25. The system for processing a transaction of claim 21, wherein the one or more computer-readable media further store instructions which, when executed by the system, cause the system to:
encode the payment interface URL in a QR code; and
wherein the QR code is subsequently printed on a purchase order receipt.

26. The system for processing a transaction of claim 21, wherein the one or more computer-readable media further store instructions which, when executed by the system, cause the system to:
encode the payment interface URL in an RFID tag.

27. The system for processing a transaction of claim 21, wherein providing a confirmation of the payment authorization to the register application further comprises:
transmitting a push notification with an order identifier for the transaction to the register application.

28. The system for processing a transaction of claim 21, wherein the one or more computer-readable media further store instructions which, when executed by the system, cause the system to:
generate an order page URL;
provide an order interface at an order page identified by the order page URL;
receive customer selection inputs for the purchase order via the order interface; and
provide the customer selections inputs for processing by the register application.

29. The system for processing a transaction of claim 28, wherein the one or more computer-readable media further store instructions which, when executed by the system, cause the system to:
request a customer phone number on the order page; and
initiate transmission of an SMS message comprising the payment interface URL to a received customer phone number based on a response to the request for a customer phone number.

30. The system for processing a transaction of claim 28, wherein the one or more computer-readable media further store instructions which, when executed by the system, cause the system to:
request login credentials for a web-based payment system on the order page; and
receive a customer phone number from the web-based payment system upon authenticating the login credentials.
